(19) United States
(12) Patent Application Publication
(10) Pub. No.: US 2021/0264411 A1
(43) Pub. Date: Aug. 26, 2021

(54) WEB MERCHANT BALANCE CASH IN VIA ATM DEPOSITS

(71) Applicant: Cardtronics USA Inc., Houston, TX (US)

(72) Inventors: Jerry McCarley, Houston, TX (US); Mohammad Fraz Ahmed, Houston, TX (US); Michael Winbun, Houston, TX (US); Tammy Marks, Houston, TX (US); Brad Nolan, Houston, TX (US); Paul Gardiner, Houston, TX (US)

(21) Appl. No.: 17/184,029

(22) Filed: Feb. 24, 2021

Related U.S. Application Data
(60) Provisional application No. 62/980,780, filed on Feb. 24, 2020.

(51) Int. Cl. G06Q 20/36; G06Q 20/10; G06Q 20/38

(52) U.S. Cl. CPC G06Q 20/3676; G06Q 20/385; G06Q 20/1085

(57) ABSTRACT

Systems and methods are provided for depositing cash into ATMs for crediting an online merchant account. In one embodiment, a method is provided that includes receiving an account identifier requested by a user at an automated teller machine (ATM). The account identifier is associated with an account with a merchant. The method may further include routing the account identifier to an application programming interface affiliated with the ATM to confirm a validity of the account identifier. In certain implementations, the method may further include implementing the transaction by accepting a deposit from the user. A settlement account is updated to reflect the deposit.

### CROSS-REFERENCE TO RELATED APPLICATIONS

The present application claims priority to U.S. Provisional Patent Application No. 62/980,780, filed on Feb. 24, 2020, the disclosure of which is incorporated herein by reference for all purposes.

### BACKGROUND

Some users are minimally involved with or do not participate in the digital economy (e.g., e-commerce, digital financial institutions, and financial institution technology) and/or card services (e.g., a financial institution banking card, credit card, or other card based service tied to an account). While traditional financial institutions (e.g., banks) and other online merchants (e.g., Venmo®, Amazon®, Apple®, and/or PayPal®) provide applications that enable users to handle certain payment and banking operations from their computing devices, the applications do not typically handle cash transactions such as deposits or withdrawals into software wallets or accounts associated with the financial institutions and online merchants.

### SUMMARY

The present disclosure presents new and innovative systems and methods for routing deposits between ATMs and online accounts (e.g., software wallets) associated with an online merchant. In one embodiment, a system and method is provided that includes receiving an account identifier requested by a user at an automated teller machine (ATM). The account identifier is associated with an account with a merchant. The system and method may further route the account identifier to an application programming interface affiliated with the ATM to confirm a validity of the account identifier. In certain implementations, the system and method may further include implementing the transaction by accepting a deposit from the user. A settlement account is updated to reflect the deposit.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates a flow diagram and components according to an exemplary embodiment of the present disclosure.

FIG. 2 illustrates a flowchart of cardless ATM access for cash deposits according to an exemplary embodiment of the present disclosure.

FIGS. 3A-3C illustrate a screen flow according to an exemplary embodiment of the present disclosure.

FIG. 4A illustrates a receipt for a successful transaction according an exemplary embodiment of the present disclosure.

FIG. 4B illustrates a receipt for a declined transaction according an exemplary embodiment of the present disclosure.

FIG. 5 illustrates a method according to an exemplary embodiment of the present disclosure.

### DETAILED DESCRIPTION OF EXAMPLE EMBODIMENTS

In many cases, customers are unable to deposit physical fiat currency (described or referred to herein as “cash”) directly into their online accounts associated with a merchant. While ATM and banking options exist for withdrawing funds from an online account associated with a financial institution, software wallets and online accounts with merchants lack cash depositing capabilities. Similarly, consumers with software wallets and/or online accounts with merchants may lack physical cards and/or mobile applications associated with the merchants such that depositing cash into the online accounts requires an additional entity (e.g., clerk operating a point of sale (POS) terminal). Further, customers may prefer the self-service interaction with ATMs to deposit cash without having to go through another entity and/or POS services. As such, consumers may therefore require a way to deposit cash into an online account (e.g., account wallets, gift card balances, and other accounts) associated with a merchant. Additionally, it may be preferable for the platform enabling such activities to be merchant-agnostic, so consumers using different software wallets or having accounts with different merchants are able to use the ATMs. One method for delivering these capabilities is to provide an application programming interface (API) that accepts cash at ATMs, verifies the customer, and deposits the funds into the online merchant (e.g., web merchant) account associated with the verified customer.

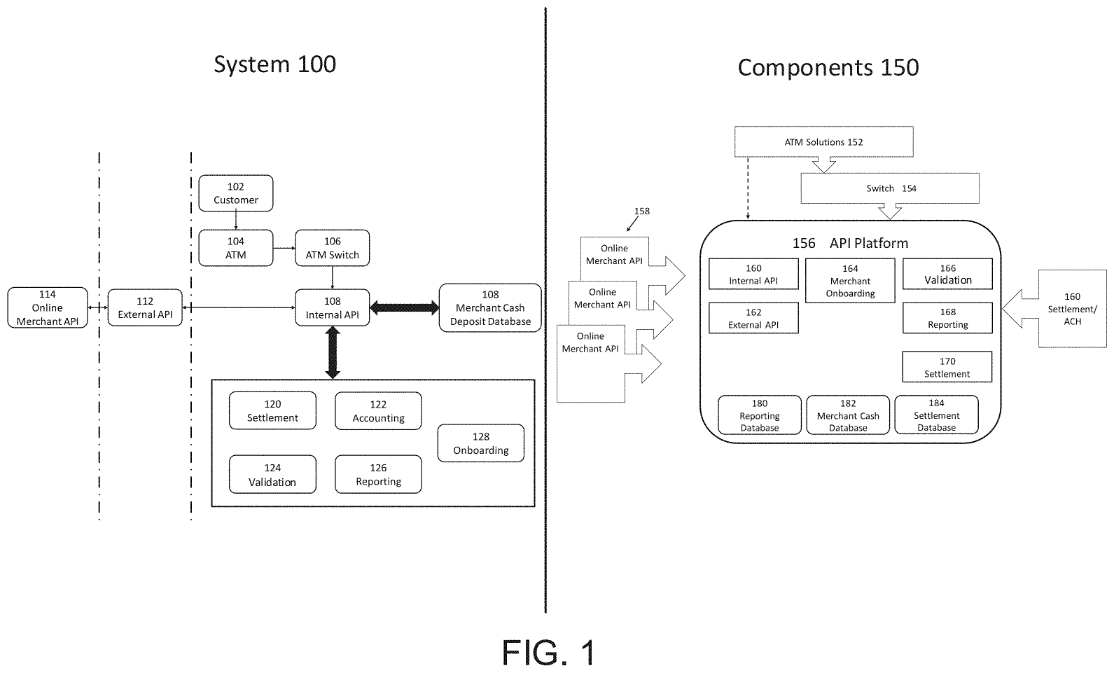

FIG. 1 depicts a system 100 and associated components 150 according to an exemplary embodiment of the present disclosure. The system 100 includes a customer 102 and an ATM 104 that interact with one another. Although an ATM 104 is depicted in FIG. 1, the system 100 may also be configured to operate with POSs. Accordingly, it should be understood that references to an ATM in the present application expressly incorporate and apply to POSs as well.

The ATM 104 may present one or more screens requesting information required to confirm, authorize, and carry out the customer 102's desired operations (e.g., depositing or withdrawing cash). The ATM 104 may be configured to prompt the customer 102 to insert cash, receive input from the customer 102, facilitate verification of a customer account associated with the online merchant, print a receipt for a transaction, and track transactions for proper settlement of funds. The system 100 is configured to bridge customers 102 with cash deposits into the digital economy.

In one embodiment, the ATM 104 connects to an ATM switch 106, which may be responsible for carrying out networking and transaction routing operations on behalf of the ATM 104. In this embodiment, the ATM switch 106 connects to an internal API 108. The internal API 108 may be provided by the same institution or company that provides the ATM 104 to properly analyze, route, verify, and confirm transactions received from the customer 102 via the ATM 104. For example, the internal API 108 may interact with a merchant cash database 108 and internal systems such as settlement systems 120, accounting systems 122, validation systems 124, reporting systems 126, and onboarding systems 158. In various embodiments, the internal API 108 is also connected to an external API 112, which may be responsible for interfacing with a merchant API 114 to verify the identity of the customer at the ATM 104 and transaction information received at the ATM 104, as explained in greater detail below. Both the external API 112 and the internal API 108 may be implemented by the same institution responsible for the ATM 104, while the merchant API 114 may be implemented by another party, such as a merchant that provides an online customer account and an associated software wallet.

In the embodiment of FIG. 1, the components 150 are exemplary components that may be responsible for implementing the system 100. The components 150 in the illustrated embodiment include ATM solutions 152, such as the ATM 104 and a switch 154, such as the ATM switch 106. The ATM solutions 152 connects to API platform 156 via the switch 154. In some implementations, the ATM solutions 152 may connect directly to the API platform 156. The API platform 156 includes an internal API 160 and an external API 162, which may respectively implement the internal API 108 and the external API 114. The API platform 156 also includes a merchant onboarding module 140, which may include documentation and other information necessary for issuer institutions to interact with the API platform 156. For example, the merchant onboarding module 140 may include information on how to configure an online merchant API 158 (e.g., online merchant API 114 of the system 100) to properly interface with, for example, the external API 162.

In the illustrated embodiment, the API platform 156 also includes a validation module 166, a reporting module 168, and a settlement module 170 respectively responsible for facilitating validation of customers 102 attempting transactions through the API platform 156, logging and reporting transactions (e.g., per regulatory requirements or business requirements), and settling accounts for individuals and issuers (e.g., via the settlement and automated clearing house (ACH) system 160. The reporting module 168 may store reporting information in the reporting database 180. The settlement module 170 may store settlement information in the settlement database 184. In some implementations, the settlement module 170 may capture a permanent account number (PAN), or account identifier with a bank identifier associated with a financial institution of the online merchant. In other implementations, extended BI Ns and mobile device info are used to identify cash deposits for adjustment and settlement purposes. The validation module 166 and/or the internal API 160 may store transaction information, validation history (e.g., successful validation attempts, failed validation attempts, canceled validation attempts) or other information in the merchant cash database 182.

In certain implementations, the system 100 may also be configured to incorporate with additional external APIs, such as the APIs of other cardless ATM or POS financial services (e.g., FIS®, Rapyd®). Further, external APIs may facilitate depositing gift cards or other merchant specific funds into the ATMs to credit a customer online account associated with the merchant. Still further external API connections may enable additional features, such as money transfers, prepaid cards, and lending services. In some implementations, external APIs may facilitate compliance with “know your customer” and anti-money laundering requirements. In certain implementations, the system 100 may also coordinate with additional external APIs to report transaction information to data aggregators, credit reporting agencies, customers, and other designated parties.

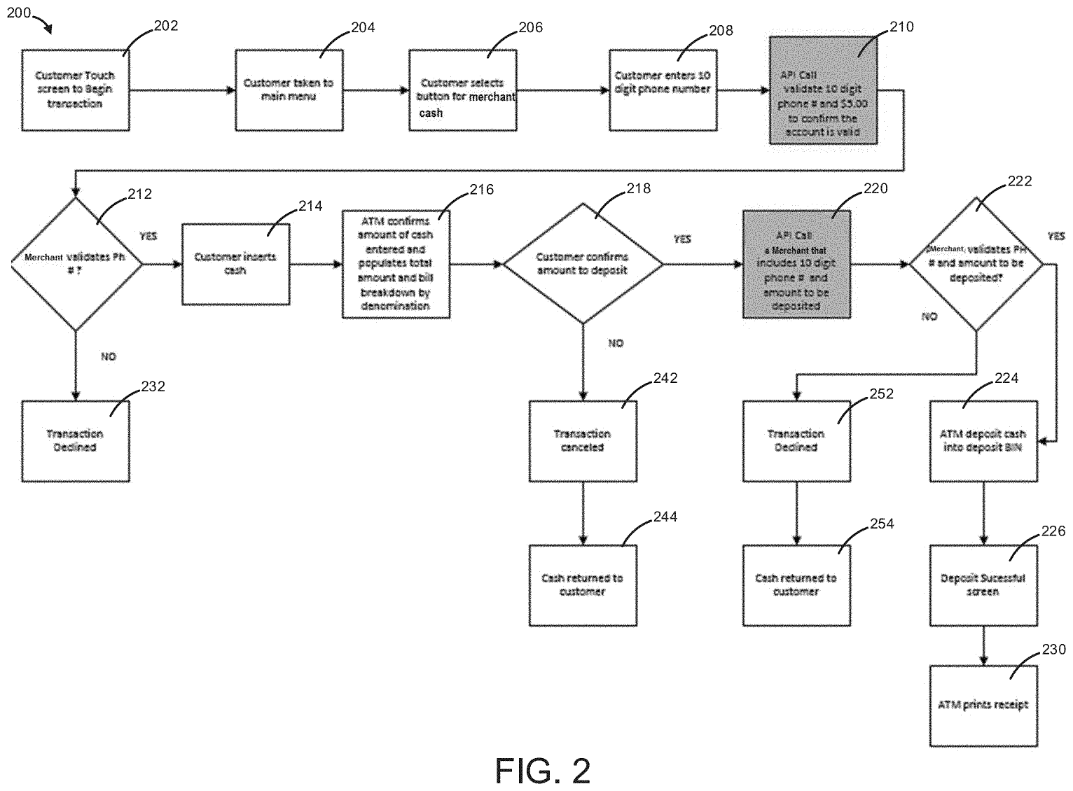

FIG. 2 depicts the steps included a method 200 for performing cash deposits into the balance of an account with an online merchant through an ATM, according to an exemplary embodiment of the present disclosure. The method 200 may be implemented or performed, in whole or in part, by a customer 104 at an ATM 104 on the system 100 of FIG. 1. The components 150 of the system 100 may facilitates the cash deposit. In the cash deposit transaction, a customer 102 may authenticate an account with an online merchant, validate the account, deposit cash into the ATM 104, and have the customer's account with the online merchant credited by the amount of cash deposited. In some implementations, the customer may deposit a gift card, character string or other code associated with an amount of funds associated with the online merchant, or other merchant specific cash into the customer's account with the online merchant through the ATM. In certain implementations, funds for deposited transactions may be transferred from the ATM entity (entity associated with the ATM) to the settlement at the end of the day. Such cash deposits may enable the customer 102 to subsequently spend the funds added to the online account (or software wallet) with the online merchant.

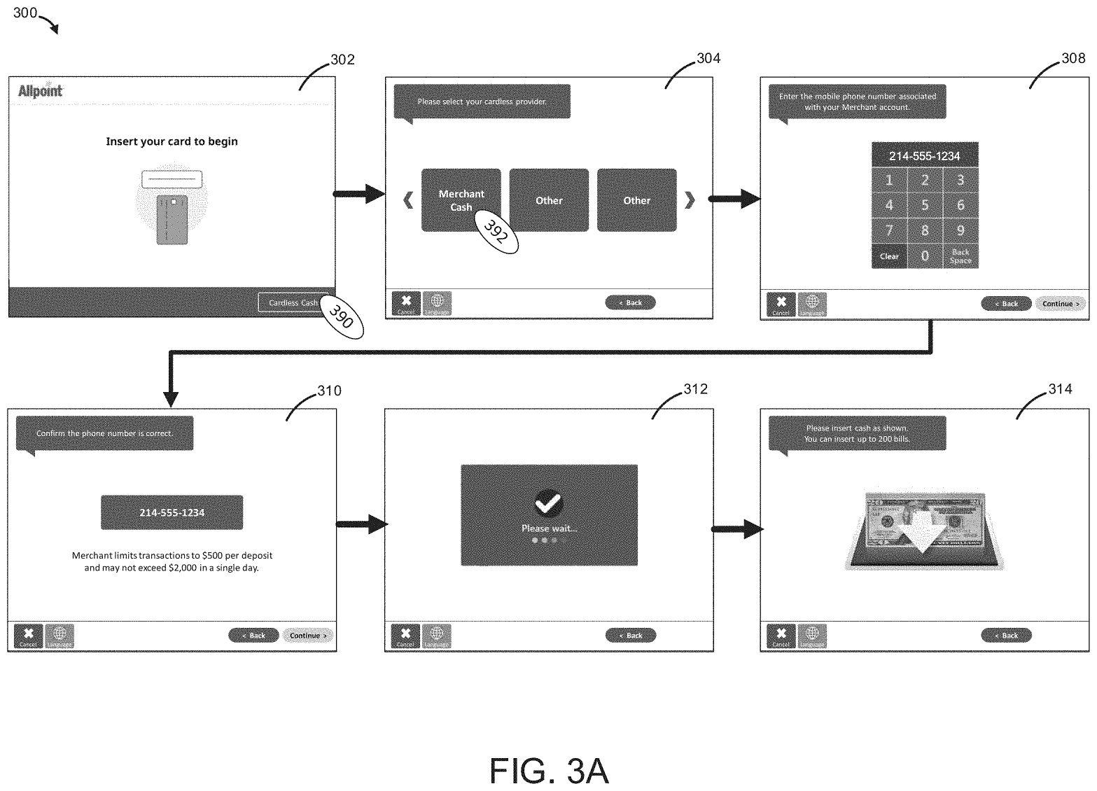

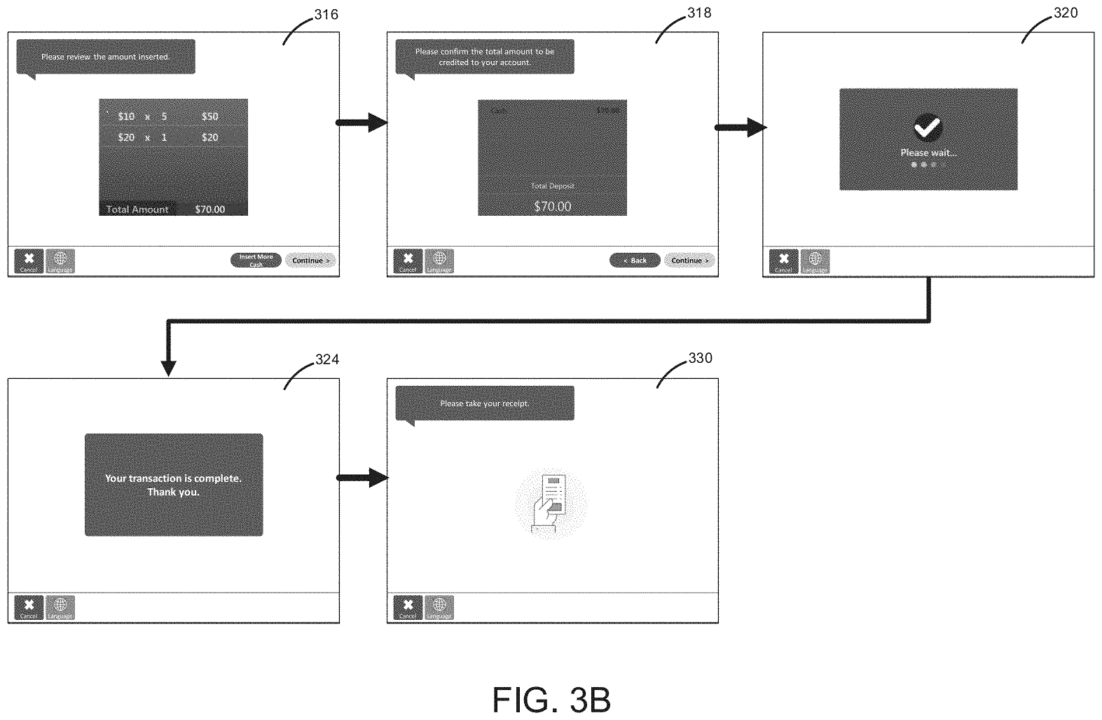

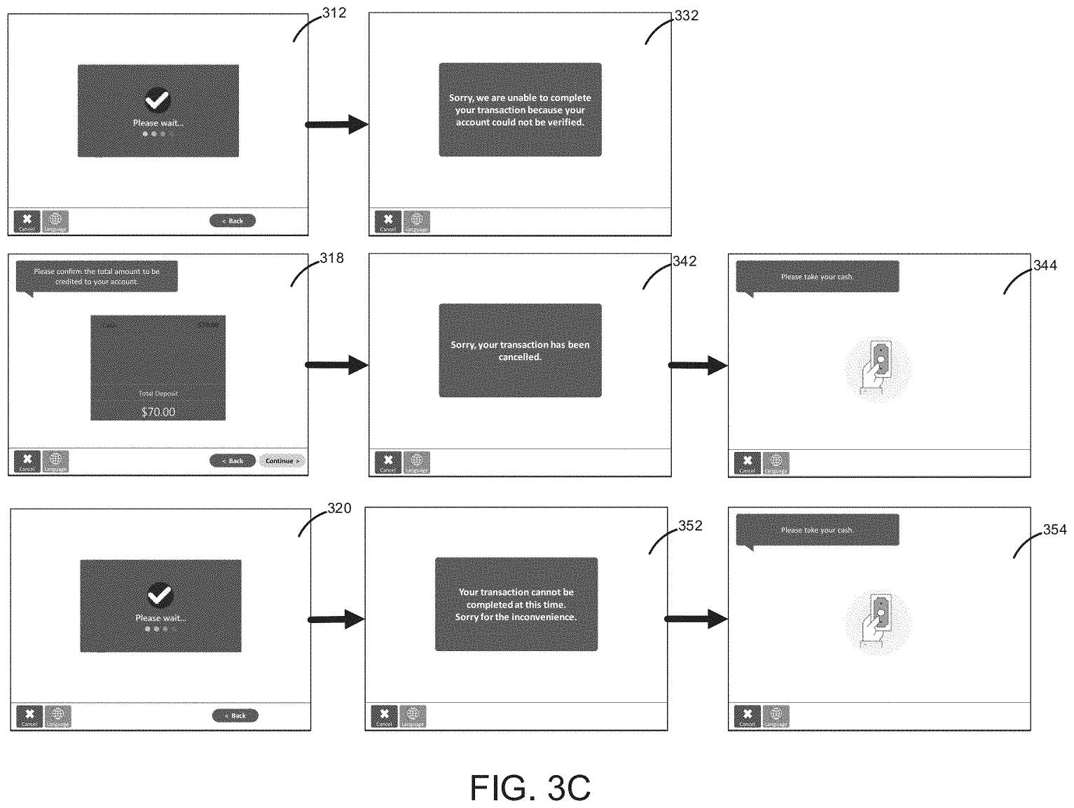

FIGS. 3A-3C depict a user interaction in the form of a flow of screen shots 300 according to an exemplary embodiment of the present disclosure. The screen flow 300 may be presented by an ATM 104 to a customer 102 to enable the customer 102 to deposit cash into the customer's online account associated with an online merchant using a customer telephone number or other unique identifier (e.g., a unique numeric identifier, a unique digital code, a unique transmission). The screen flow 300 may be present at various steps along a method for performing cash deposits into the balance of an account with an online merchant through an ATM. For example, and as described in greater detail below, the screen flow 300 may be presented during various steps of the method 200 for performing cash deposits of FIG. 2. The description that follows relates the various steps of the exemplary method 200 to various screen shots of the flow 300 to aid in the understanding of the performance of the exemplary embodiments of the disclosed system and methods.

With regard to the embodiment of FIG. 2, at step 202, a customer 102 goes to an ATM 104 participating in the system 100 of providing cash deposits and touches the screen of the ATM 104 to access the menu associated with cash deposits. As shown on screen 302 of FIG. 3A, the customer 102 is presented with a selection between a traditional ATM transaction (through insertion of a debit or credit card) and a cardless cash deposit with an online merchant transaction. The customer 102 may select a “cardless cash” option 390 on the screen of the ATM 104 to begin the cash deposit transaction.

At step 204, the customer 102 is presented with a main menu listing the various online merchants available for cash deposits. In some implementations, the customer 102 may search through a list of participating online merchants to identify the online merchant associated with the online account the customer 102 wants to deposit cash into. As shown on screen 304 of FIG. 3A, the participating online merchants (e.g., cardless providers) may be listed on a scrollable list.

At step 206, the customer 102 selects the button listing the online merchant associated with the online account the customer 102 wants to deposit cash into. The customer may select the online merchant “Merchant Cash” 392 to deposit cash into the online account of Merchant Cash, as shown on screen 304 of FIG. 3A.

At step 208, the customer 102 enters the ten-digit phone number registered with (e.g., associated with) the online account of the online merchant selected at step 206. The ATM 104 may provide a physical keypad or a digital, hepatic keypad (as shown in screen 308 of FIG. 3A) to have the customer 102 enter the phone number. In some implementations, the customer 102 may be given the option to enter an account name, an account number, a character string, QR code, or other account identifier for the online account of the online merchant selected at step 206. In some implementations, and as shown in screen 310 of FIG. 3A, the ATM 104 may request that the customer 102 confirms the entered phone number and may provide merchant imposed (or ATM imposed) deposit limits (e.g., transaction limits, daily limits, monthly limits, and other account limits).

At step 210, the ATM 104 sends a validation request and the provided ten-digit phone number to the online merchant API 114 associated with the ten-digit phone number. In some implementations, the ATM 104 connects to the online merchant API 114 through the internal API 108 or other component of the API platform 156. In other implementations, the ATM 104 may include a list of authorized and registered phone numbers associated with the online merchant, for example, in the merchant cash database 182, and validate the customer within the API platform 156. In some implementations, the API platform 156 may confirm a merchant imposed minimum deposit amount along with the validation request. In other implementations, the API platform 156 may temporarily credit or transmit a currency amount, for example, five dollars, to the online merchant API 114.

At step 212, the online merchant API 114 validates the phone number provided by the customer 102 at the ATM 104. During the validation by the online merchant API 114 a waiting screen may be presented to the customer, such as screen 312 of FIG. 3A. In some implementations, the online merchant API 114 may send a text message or other push notification to the customer 102 to validate and verify the customer 102.

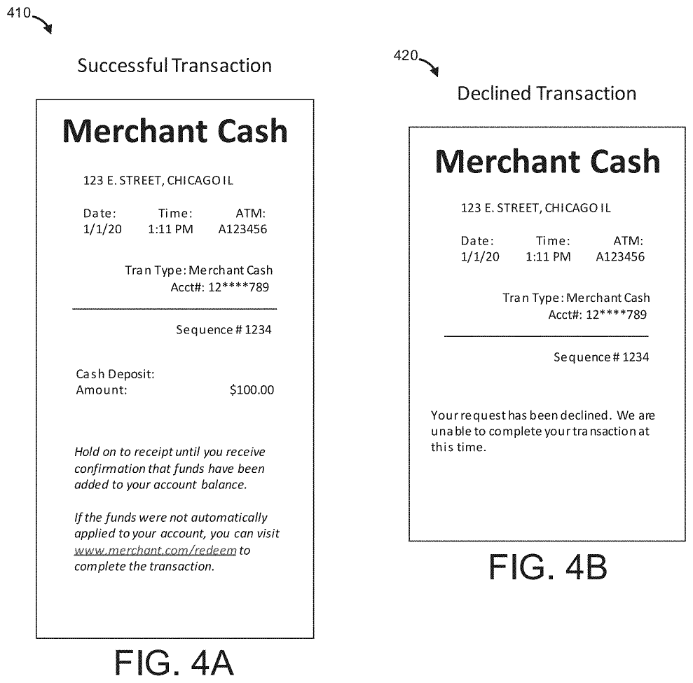

If the online merchant API 114 does not validate the phone number, the online merchant API 114 transmits a failed validation to the API platform 156 at step 232. A failed validation may result in the ATM 104 presenting a failed validation screen 332, as shown in FIG. 3C, to the customer 102. In those implementations, the ATM 104 may print a decline transaction receipt, such as the receipt 420 shown in FIG. 4B, to give the customer 102 documentation and information regarding the declined transaction.

If the online merchant API 114 does validate the phone number, a validation approval is sent to the API platform 156 and the ATM 104 prompts the customer 102 to insert cash into the ATM, at step 214. The customer 102 may be prompted to deposit cash by being shown screen 314 of FIG. 3A.

At step 216, the ATM 104 confirms the amount of cash entered and populates the total amount of cash deposited and the cash bill breakdown by denomination. The ATM 104 may present the denomination breakdown and amount of denomination inserted by the customer 102 on a screen 316, as shown in FIG. 3B. In some implementations, the customer 102 may be able to cancel the transaction and receive back the cash deposited at this screen 316. In some implementations, the ATM 104 may reject a transaction if the deposited cash is less than the minimum amount required for a single transaction and/or exceeds the maximum limits for the account.

At step 218, the customer 102 confirms the amount of cash deposited into the ATM 104. A confirmation screen 318, as shown in FIG. 3B, may be presented to customer 102 to confirm the deposit amount and continue with the deposit transaction.

If the customer declines the amount to deposit, the transaction canceled at step 242 and the deposited cash is returned to the customer 102 at step 244. Screen 342 of FIG. 3C may be presented to the customer 102 and screen 344 may be subsequently shown to the customer to prompt them to remove the returned cash. A canceled transaction may result in the ATM 104 presenting a canceled transaction screen 342, as shown in FIG. 3C, to the customer 102. In those implementations, the ATM 104 may print a declined transaction receipt, such as the receipt 420 shown in FIG. 4B, to give the customer 102 documentation and information regarding the declined transaction.

Once the deposit amount is confirmed by the customer 102, the ATM 104 transmits the validated phone number and amount deposited to the online merchant API 114 for validation at step 220. A waiting screen 320, as shown in FIG. 3B, may be presented to the customer 102 while the ATM 104 transmits the validated phone number and amount deposited to the online merchant API 114.

At step 222, the online merchant API 114 validates the phone number and amount approved by the customer 102 for deposit. For example, the online merchant API 114 may validate that the deposit amount of the customer 102 is above the minimum daily amount and below maximum limits for the account. If the online merchant API 114 does not validate the deposit transaction, the online merchant API 114 transmits a failed validation to the API platform 156 at step 252. A failed validation may result in the ATM 104 presenting a failed transaction screen 352, as shown in FIG. 3C, to the customer 102. In those implementations, the ATM 104 may print a failed transaction receipt, such as the receipt 420 shown in FIG. 4B, to give the customer 102 documentation and information regarding the declined transaction.

If the online merchant API 114 does validate the phone number, a validation approval is sent to the API platform 156 and the ATM 104 deposits the cash into the deposit bin at step 224. In some implementations, once the customer 102 confirms the amount at step 218, the transaction is approved and the ATM deposits the cash into the deposit bin at step 224 and the internal API 108 transmits the load information (e.g., deposit information) to the online merchant API 114.

At step 226, the deposit is successful and the deposit transaction is completed. A transaction completion screen 324 of FIG. 3B may be presented to the customer 102 upon completed of the transaction and depositing of the cash into the deposit BIN. A completed transaction may result in the ATM 104 presenting a completed transaction screen 330, as shown in FIG. 3B, to the customer 102. In those implementations, the ATM 104 may print a completed transaction receipt, such as the receipt 410 shown in FIG. 4A, to give the customer 102 documentation and information regarding the completed transaction.

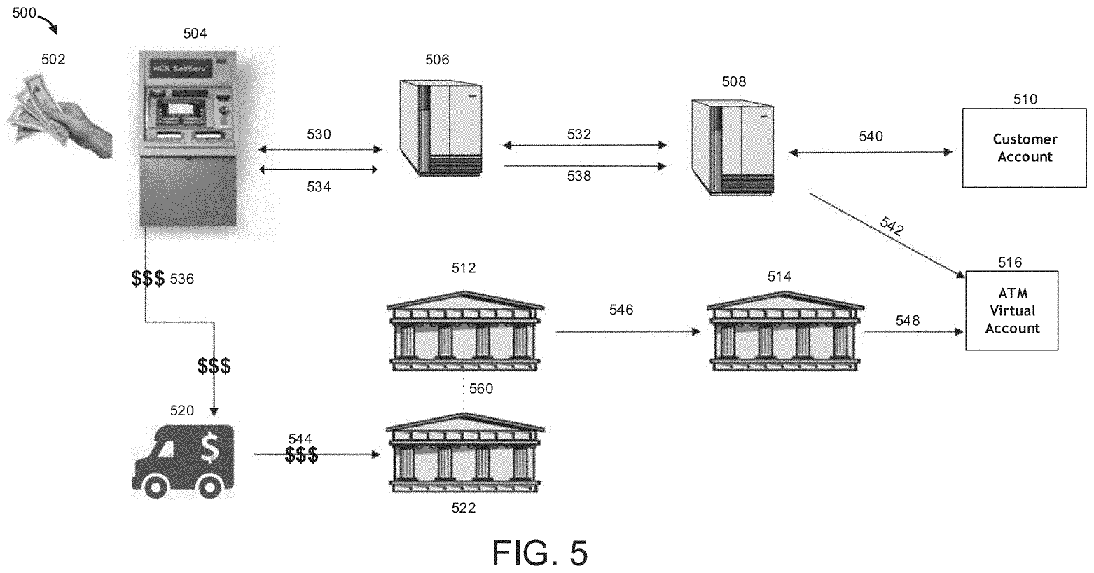

FIG. 5 depicts a method 500 for performing a cash deposit according to an exemplary embodiment of the present disclosure. In a cash deposit, the online merchant may directly participate in the validation of a customer account associated with the customer attempting the cash deposit at an ATM and may transfer the corresponding funds at least once each day (e.g., via a daily ACH) inclusive of the preceding transactions (e.g., cash deposits). The method 500 may be implemented to enable cash deposits by a customer 502 at an ATM 504 associated with an ATM API 506 to be deposited into a customer account 510 associated with (e.g., enrolled with, provided by) an online merchant 508. The ATM API 506 may be operated by an ATM entity.

The method 500 begins at step 530 when the customer 502 initiates a cash deposit transaction at an ATM 504 by providing an account identifier associated with (e.g., identifying) the customer account 510. The ATM 504 may connect to the API 506 to authorize the information provided by the customer 102.

At step 532, the API 506 verifies if the account identifier (e.g., phone number) exists with the online merchant 508. The API of the online merchant 508 validates that the provided account identifier is associated with a customer account 510 that exists with the online merchant 508. Once verified, the online merchant 508 provides a positive validation to the API 506.

At step 534, the API 506 transmits the validation of the customer account 510 to the ATM 504. If the account is not validated, the transaction may be declined. In some implementations, the API 506 may further validate or verify the customer's 102 identity. Other methods of verifying the customer 102's identity may include the customer 102's identity being verified by a third party regulatory services provider. For example, the regulatory services provider may provide an API that assists companies in complying with “know your customer,” anti-money laundering, and customer identification regulatory requirements. In such instances, the API 506 may invoke the regulatory services provider's API to verify the customer 102's identity.

At step 536, the customer 502 deposits the cash into the ATM 504 and the cash is deposited into a bin within the ATM 504.

At step 538, the API 506 creates settlement totals for the load amounts associated with the online merchant 508. In some implementations, the settlement totals for the load amounts are created on at least a daily occurrence. In some implementations, the settlement account may reconcile with a merchant settlement account affiliated with the merchant 508. For example, the settlement account or the ATM entity may send an ACH debit daily to the merchant settlement account for all approved transactions redeemed at ATMs 608 provided by the ATM entity.

At step 540, the online merchant 508 applies the load (e.g., deposit amount) for the customer account 510 from the settlement total for the load amounts provided on at step 538. In some implementations, the online merchant 508 may credit the customer account 510 after debiting the virtual account the entity that operates the ATM (ATM virtual account 516) has with the online merchant 508.

At step 542, the online merchant 508 will net debit the ATM virtual account 516 at the time of receiving the settlement totals for the online load amount provided at step 538. In some implementations, the net debit of the ATM virtual account 516 occurs before loading funds to the customer account 510. Through this process, the online merchant 508 is able to directly provide funds to the customer account 510 while receiving the funds through the debit on the ATM virtual account 516 that the entity that operates the ATMs 504 has with the online merchant 508.

At step 544, an armored truck 520 or other transport moves the physical cash from the ATMs 504 to the financial institution 522 associated with the ATM entity (e.g., the financial institution that the ATM entity that operates the ATM 504 has an account with). In some implementations, the physical cash is transported to a location operated by the entity that operates the ATM 504.

At step 560, the physical cash deposited at the financial institution 522 in the ATM bank account is credited to the online account of the ATM 512 at the financial institution. At step 546, the ATM entity transmits funds from the ATM entity financial institution account 512 to an online merchant pooled account 514. In some implementations, the ATM entity will initially pre-fun the online merchant pooled account 514 and/or ATM virtual account 516 and may increase or decrease the account in accordance with amount of cash deposits at ATMs 504.

At step 548, the online merchant 508 moves the funds from the online merchant pooled account 514 to the ATM virtual account 516 that the ATM entity has with the online merchant 508. In some implementations, credits and debits will flow through the ATM virtual account 516 in real time to allow the ATM entity to monitor and reconcile.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
receiving an account identifier requested by a user at an automated teller machine (ATM), the account identifier associated with an account with a merchant;
routing the account identifier to an application programming interface (API) affiliated with the ATM to confirm a validity of the account identifier;
implementing the transaction by accepting a deposit from the user; and
updating a settlement account to reflect the deposit.
